(19) United States
(12) Patent Application Publication
(10) Pub. No.: US 2009/0168878 A1
(43) Pub. Date: Jul. 2, 2009

(54) MOVING PICTURE CODING DEVICE, MOVING PICTURE CODING METHOD, AND RECORDING MEDIUM WITH MOVING PICTURE CODING PROGRAM RECORDED THEREON

(75) Inventor: Yuji Kawashima, Hamura-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/341,851

(22) Filed: Dec. 22, 2008

(30) Foreign Application Priority Data
Dec. 26, 2007 (JP) 2007-335288

(51) Int. Cl. H04N 11/02

(52) U.S. Cl. 375/240.13; 375/E07.076

(57) ABSTRACT

According to one embodiment, a moving picture coding device regarding the invention comprises a coding module which codes moving picture data in macroblocks, a coding information analysis module which analyzes coded pictures and coding information of macroblocks at the coding module, and a coding control module which issues an instruction of coding to the coding module in pictures or in macroblocks on the basis of an analysis result of the coding analysis module, wherein the coding analysis module performs still area determination and flat area determination for each coding target macroblock, and the coding control module applies intra flicker suppression processing to macroblocks which have been in a still area and also in a flat area by the coding analysis module.

### CROSS-REFERENCE TO RELATED APPLICATIONS

This application is based upon and claims the benefit of priority from Japanese Patent Application No. 2007-335288, filed Dec. 26, 2007, the entire contents of which are incorporated herein by reference.

### BACKGROUND

1. Field

One embodiment of the present invention relates to a moving picture coding device and a moving picture coding method which perform compression coding on moving picture data depending on an algorithm, such as a moving picture experts group (MPEG), and a recording medium with moving picture coding program recorded thereon.

2. Description of the Related Art

In a moving picture coding device that relies on an MPEG system, etc., for example, an intra flicker suppression method, which detects a still area having a possibility of generating a flicker by means of an absolute difference value of a luminance average value, detects a flat area by calculating a distribution, etc., of pixel values, and changes a quantization parameter of the areas is used (e.g., refer to Jpn. Pat. Appln. KOKAI Publication 2007-067469).

However, when detecting an area to be applied with such processing, the conventional intra flicker suppression method given above performs processing to calculate an inter-frame difference value in an original picture as still area determination and processing to calculate activity of the original picture as flat area determination. These steps of processing are processing to be added so as to suppress flicker having no relation to the coding processing itself, and it has been desired to reduce these steps of processing in order to reduce the load incurred on the coding processing.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram depicting an embodiment of a moving picture coding device regarding the invention;

FIG. 2 is a schematic view depicting spots at which flicker is apt to be generated in the moving picture coding device;

FIG. 3 is a flowchart depicting a processing procedure in macroblocks in intra flicker suppression processing determination in an I picture at the coding device in FIG. 1;

FIG. 4 is a flowchart depicting a determination procedure depending on a size of a motion vector in still area determination of the embodiment;

FIG. 5 is a flowchart depicting a determination procedure depending on the number of items of skip coding selection in the still area determination of the embodiment;

FIG. 6 is a flowchart depicting a determination procedure depending on motion detection sum of absolute difference (SAD) in the still area determination of the embodiment;

FIG. 7 is flowchart depicting a determination procedure depending on the number of items of selection of 16×16 prediction block sizes in flat area determination of the embodiment;

FIG. 8 is a flowchart depicting a determination procedure depending on the number of items of selection of intra 16×16 in an optimum intra prediction mode in coding or mode determination in the flat area determination of the embodiment;

FIG. 9 is a flowchart depicting a determination procedure depending on the number of remaining difference signal non-zero coefficients in the optimum intra prediction mode in the coding or the mode determination in the flat area determination of the embodiment;

FIG. 10 is a schematic view depicting an example in which a macroblock (C1): the same coordinate position macroblock in a coded picture just before is used as a determination target block in the still area and the flat area determination of the embodiment;

FIG. 11 is a schematic view depicting an example in which a macroblock (C2): the same coordination position macroblock of the (C1) and a macroblock which is adjacent to the position macroblock are used as determination target block in the still area and the flat area of the embodiment;

FIG. 12 is a schematic view depicting an example in which a macroblock (C3): the same coordinate position macroblocks of all the coded pictures are used as determination target blocks in the still area and the flat area of the embodiment; and

FIG. 13 is a schematic view depicting an example in which a macroblock (C4): the position macroblocks of the (C3) and macroblocks adjacent to the position macroblocks are used as determination target blocks in the still area and the flat area of the embodiment.

### DETAILED DESCRIPTION

Various embodiments according to the invention will be described hereinafter with reference to the accompanying drawings. In general, according to one embodiment of the invention, there is provide a moving picture coding device which comprises a coding module which codes moving picture data in macroblocks, a coding information analysis module which analyzes coded pictures and coding information of macroblocks at the coding module, and a coding control module which issues an instruction of coding to the coding module in pictures or in macroblocks on the basis of an analysis result of the coding analysis module, wherein the coding analysis module performs still area determination and flat area determination for each coding target macroblock, and the coding control module applies intra flicker suppression processing to macroblocks which have been in a still area and also in a flat area by the coding analysis module.

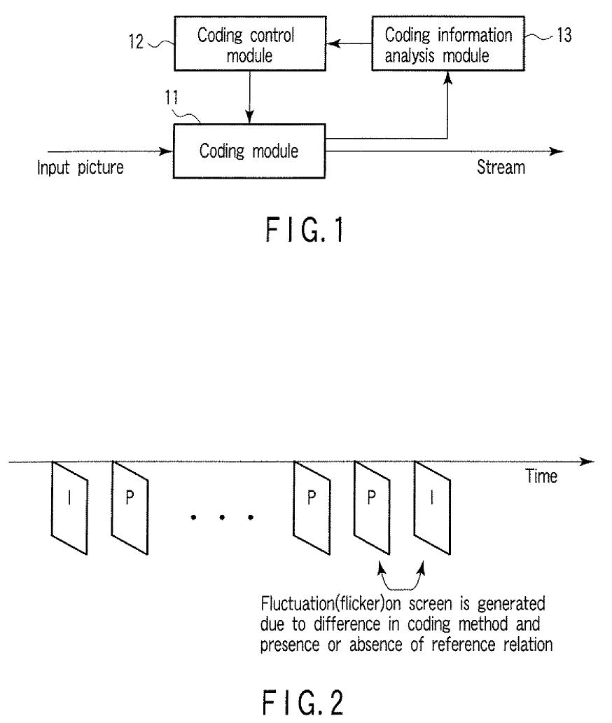

FIG. 1 is a block diagram illustrating an embodiment of a moving picture coding device regarding the invention. The coding device is composed of a coding module 11, a coding control module 12, and a coding information analysis module 13.

The coding module 11 encodes input moving picture data in macroblocks, for example, of 16×16 pixels to output the coded data in a stream form. The coding control module 12 instructs coding in pictures or in macroblocks to the coding module 11 on the basis of the information acquired from the analysis module 13. As the instruction, a quantization parameter, a coding type, etc., can be used.

The analysis module 13 analyzes coding information of coded pictures and macroblocks to output the analysis result to the control module 12. The coding information includes coding determination information such as a coded quantization conversion coefficient, pre-entropy-coded information such as a prediction mode and a motion vector, post-entropy-coded information such as an occurrence code amount, coding cost in each mode used in mode selection for coding, and sum of absolute difference (SAD) in addition to the quantization parameter and a coding parameter such as a coding type.

In a coding device having the given configuration, a moving picture generates a fluctuation (flicker) on a screen due to a difference in coding method and presence or absence of reference relations. Especially, as shown in FIG. 2, the fluctuation is apt to be generated at the time when the picture is switched from a P picture to an I picture (intra flicker).

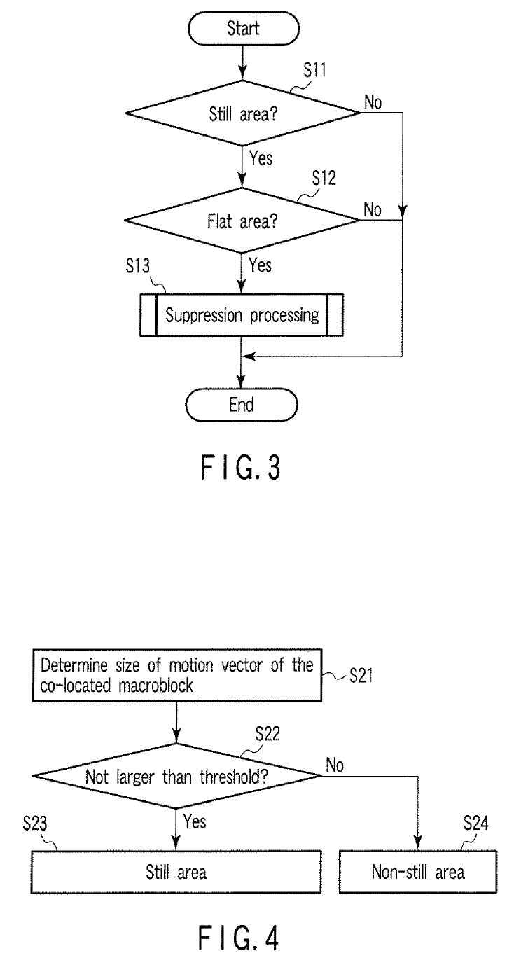

Hereinafter, a processing procedure in macroblocks in intra flicker suppression processing determination at the I picture will be described by referring to the flowchart shown in FIG. 3.

At first, the analysis module 13 performs (A) still area determination and (B) flat area determination of the coding target macroblock. The control module 12 receives the result from the analysis module 13, and applies the intra flicker suppression processing to the macroblock which is determined that to be in the still area in Block S11, and also in the flat area in Block S12 (Block S13). As regards the intra flicker suppression processing, a method for making the quantization parameter smaller, or changing the quantization parameter so as to be smaller than a prescribed value can be used. In a case in which it is determined that the macroblock is not in the still area and the flat area in Blocks S11, S12, it is assumed that the processing procedure does not perform the intra flicker suppression processing (Block S14).

Hereinafter, the (A) still area determination, the (B) flat area determination and the determination target blocks of the (A), (B) determination will be described.

(A) Still Area Determination

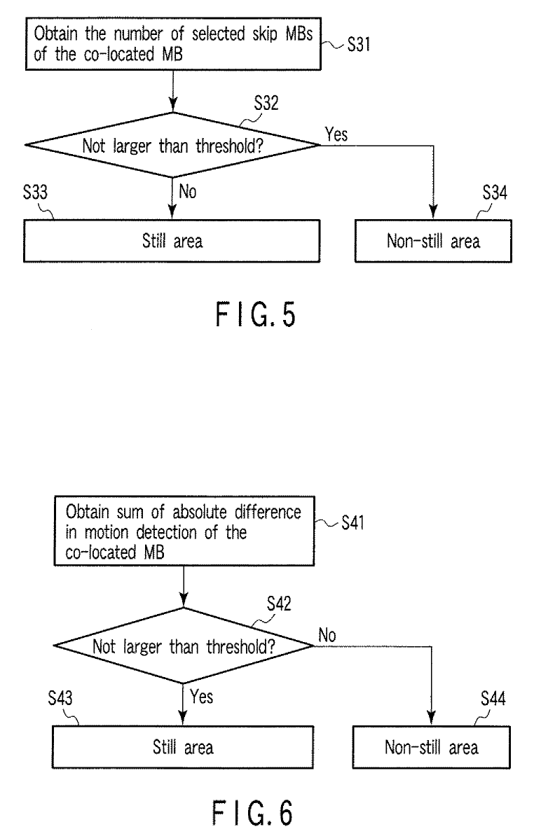

Determining the still area uses a condition (A1): the size of the motion vector (FIG. 4), a condition (A2): the number of items of skip coding selection (FIG. 5), and a condition (A3): the SAD at the motion detection module (FIG. 6) of the determination target macroblocks. The still area determination may be set in a case that all the conditions (A1), (A2), (A3) are satisfied, and may be set in a case that any one of them is satisfied. The combination of the conditions (A1), (A2), (A3) may be used.

FIG. 4 shows the determination procedure depending on (A1) the size of the motion vector, the determination procedure obtains the size of the motion vector of the co-located macroblock (Block S21), compares the size of the motion vector with a threshold (Block S22), determines that the target macroblock is in the still area if the size of the motion vector is equivalent to the threshold or smaller (Block S23), and determines that the target macroblock is in a non-still area if the size of the motion vector is not equivalent to the threshold or smaller (Block S24).

FIG. 5 shows the determination procedure depending on (A2): the number of items of selected skip coding, which comprises obtaining the number of skipped macroblocks of the co-located macroblocks (Block S31), comparing the number of the selected skip macroblocks with a threshold (Block S32), determining that the target macroblock is in the still area if the number is not equivalent to the threshold or smaller (Block S33), and determining that the target macroblock is in a non-still area if the number is equivalent to the threshold or smaller (Block S34).

FIG. 6 shows the determination procedure depending on the (A3): the SAD at the motion detection module, which comprises obtaining the SAD at the motion detection of the same coordinate position macroblock (Block S41), comparing the SAD with the threshold (Block S42), and determining that the determination target macroblock is in the still area if the SAD is not larger than the threshold (Block S43), and determining that the target macroblock is in the non-still area if the SAD is larger than the threshold (Block S44).

(B) Flat Area Determination

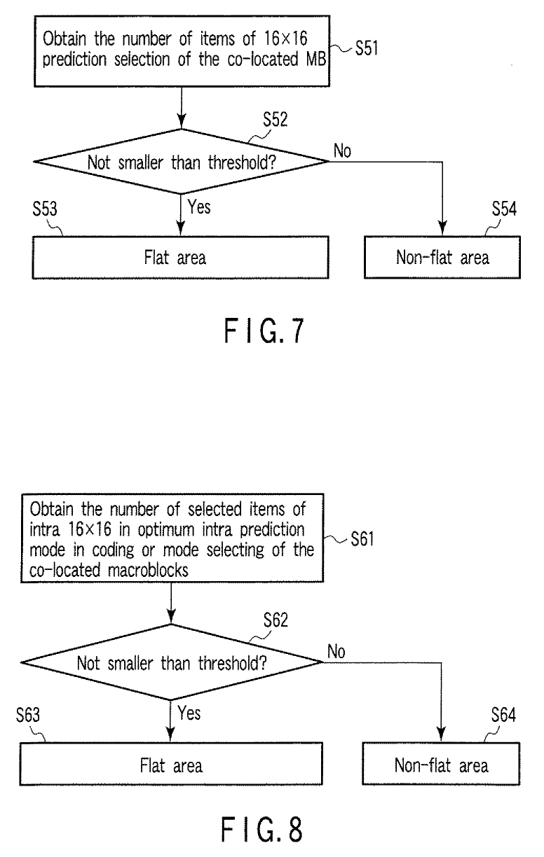

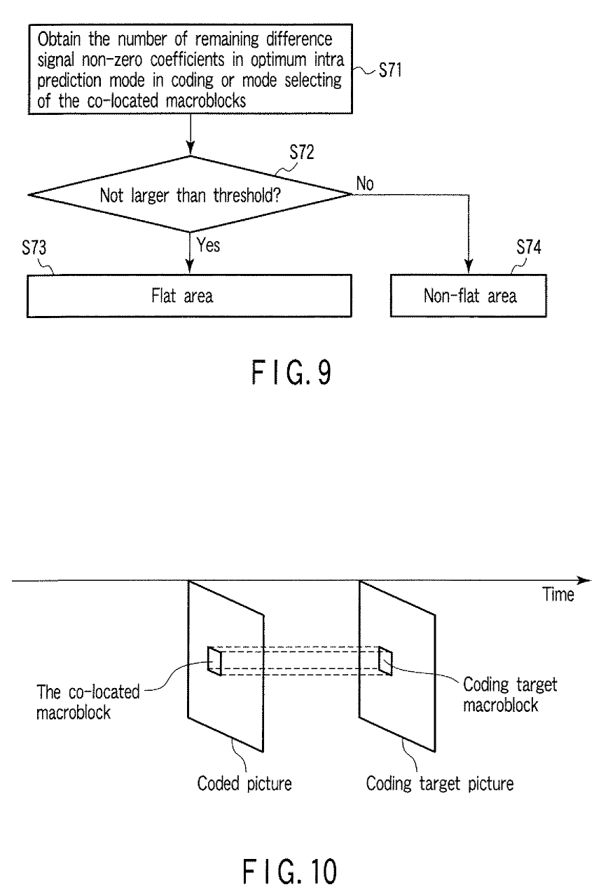

Determining the flat area uses a condition (B1): the number of selected 16×16 prediction block sizes (FIG. 7), a condition (B2): the number of items of selected intra 16×16 in the optimum intra prediction mode in coding or in mode determination (FIG. 8), and a condition (B3): the number of the remaining difference signal non-zero coefficients in the optimum intra prediction mode in coding or in node determining (FIG. 9). The flat area determination may be set in a case that all the conditions (B1), (B2), (B3) are satisfied, and may be set in a case that any one of them is satisfied. The combination of the conditions (B1), (B2), (B3) may be used.

FIG. 7 shows the determination procedure depending on the (B1): the number of the selected 16×16 prediction block sizes, which comprises obtaining the number of items of 16×16 prediction selection (Block S51), comparing the number of items of 16×16 prediction selection with the threshold (Block S52), and determining that the target macroblock is in the flat area if the number is equivalent to the threshold or larger (Block S53), and determining that the target macroblock is in the non-flat area if the number is not equivalent to the threshold or larger (Block S54).

FIG. 8 shows the determination procedure depending on the (B2): the number of items of selected intra 16×16 in the optimum intra prediction mode in the coding or mode determining, which comprises obtaining the number of selected items of intra 16×16 in the optimum intra prediction mode in the coding or mode selecting of the same coordinate position macroblock (Block S61), comparing the number of the selected items of the intra 16×16 with the threshold (Block S62), and determining that the determination target macroblock is in the flat area if the number is equivalent to the threshold or larger (Block S63), and determining that the target macroblock is in a non-determination area if the number is not equivalent to the threshold or larger (Block S64).

FIG. 9 shows the determination procedure depending on the (B3) the number of the remaining difference signal non-zero coefficients in the optimum intra prediction mode in coding or in mode determining; which comprises obtaining the number of the remaining difference signal non-zero coefficients in coding of the same coordinate position macro block or in the optimum intra prediction mode in the mode selecting (Block S71). The procedure then compares the number with the threshold (Block S72), determines that the target macroblock is in the flat area if the number is not larger than the threshold (Block S73), and determines that the target macroblock is in the non-flat area if the number is larger that the threshold (Block S74).

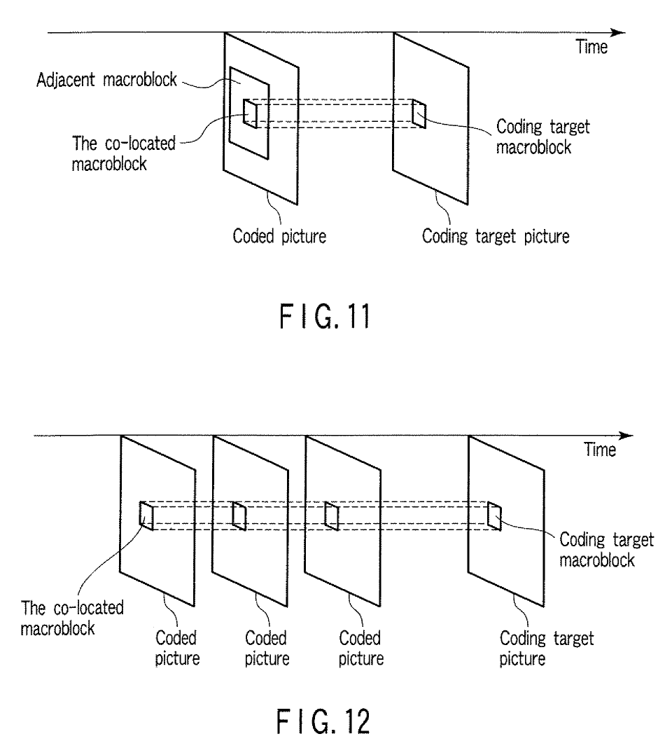

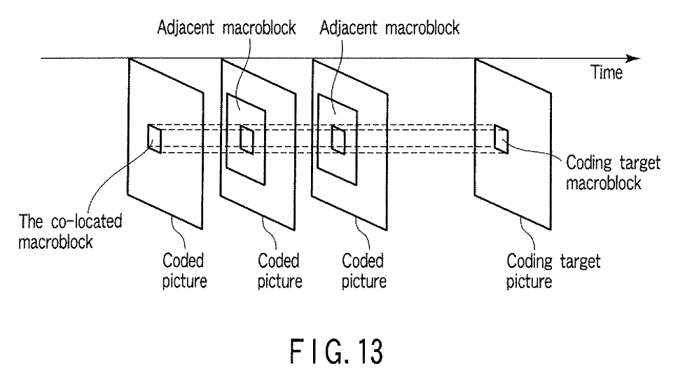

For the aforementioned determination target block, (C1): the same coordinate position macroblock at a coded picture at just before (FIG. 10), (C2): the macroblock (C1) and a macroblock which is adjacent to the macroblock (C1) (FIG. 11), (C3): the same coordinate position macroblocks of all the coded pictures (FIG. 12), and (C4): the macroblock (C3) and the macroblock which is adjacent to the macroblock (C3) (FIG. 13) are used. ‘all the coded pictures’ of the macroblocks (C3), (C4) may be set to ‘all the coded pictures in GOP’. For the coded pictures of the macroblocks (C1)-(C4), only a reference picture may be targeted, and a non-reference picture need not be targeted.

FIG. 10 shows an example that in the macroblock (C1): the same coordinate position macroblock at the coded picture just before is used as the determination target block. FIG. 11 shows an example that the macroblock (C2): the macroblock (C1) and the macroblock which is adjacent to the macroblock (C1) are used as the determination target block. FIG. 12 shows an example that the macroblock (C3): the same coordinate position macroblocks of all the coded pictures are used as the determination target block. FIG. 13 shows an example that the macroblock (C4): the macroblock (C3) and the macroblock which is adjacent to the macroblock (C3) are used as the determination target blocks.

According to the aforementioned processing, in detecting the area having the possibility of the occurrence of the flicker, since a calculation solely for detection is not performed, and the result of the calculation in the coding mode and the motion detection of the coded picture is used, flicker suppression may be achieved through almost the same processing amount as that of the convention processing. Especially, the moving picture coding device regarding the invention may become an effective means for real-time encode processing.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A moving picture coding device, comprising:
a coding module which codes moving picture data in macroblocks;
a coding information analysis module which analyzes coding information of coded pictures and macroblocks at the coding module; and
a coding control module which issues an instruction of coding to the coding module in pictures or in macroblocks on the basis of an analysis result of the coding analysis module, wherein
the coding analysis module performs still area determination and flat area determination for each coding target macroblock; and
the coding control module applies intra flicker suppression processing to macroblocks which have been in a still area and also in a flat area by the coding analysis module.

2. The moving picture coding device of claim 1, wherein
the still area determination determines that the coding target macroblock is in the still area if at least any one of size of motion vector of the determination target, the number of items of skip coding selection thereof, and a sum of absolute difference in motion detection thereof satisfies determination conditions.

3. The moving picture coding device of claim 1, wherein
the flat area determination determines that the coding target macroblock is in the flat area if at least any one of the number of selected prediction block sizes of the coding target macroblocks of the determination target; the number of selected sizes of motion vector thereof; the number of selected intra macroblocks in an optimum intra prediction mode in coding or mode determining thereof; and the number of the residual signal non-zero coefficients in the optimum intra prediction mode in coding or mode determining thereof satisfies determination conditions.

4. The moving picture coding device of claim 1, wherein
the coding analysis module uses at least any one of the same coordinate position macroblock in a coded picture just before; the same coordinate position macroblock and its adjacent macroblock; the macroblock just before, its adjacent macroblock and the same coordinate position macroblocks of all the coded pictures; and the macroblock just before, its adjacent macroblock, the same coordinate position macroblocks of all the coded pictures and their adjacent macroblock are used as a block to be determined for being in the still area or the flat area.

5. A moving picture coding method, comprising:
coding moving picture data in macroblocks;
analyzing coding information of coded pictures and macroblocks of the coding; and
issuing an instruction of coding control in pictures or in macroblocks to the coding on the basis of the analysis result of the coding information, wherein
the analyzing coding information performs still area determination and flat area determination for each coding target macroblock; and
the coding control applies intra flicker suppression processing to macroblocks which have been in a still area and also in a flat area by the coding analysis module.

6. The moving picture coding method of claim 5, wherein
the still area determining determines that the coding target macroblock is in the still area if at least any one of size of motion vector of the determination target, the number of items of skip coding selection thereof, a sum of absolute difference in motion detection thereof satisfies determination conditions.

7. The moving picture coding method of claim 5, wherein
the flat area determining determines that the coding target macroblock is in the flat area if at least any one of the number of selected prediction block sizes of the coding target macroblock of the determination target, the number of selected sizes of motion vector thereof, the number of selected intra macroblocks in an optimum intra prediction mode in coding or mode determining thereof, and the number of the residual signal non-zero coefficients in the optimum intra prediction mode in coding or mode determining thereof satisfies determination conditions.

8. The moving picture coding method of claim 5, wherein
the coding analyzing uses at least any one of the same coordinate position macroblock in a coded picture just before, the same coordinate position macroblock and its adjacent macroblock, the macroblock just before, its adjacent macroblock and the same coordinate position macroblocks of all the coded pictures, the macroblock just before, its adjacent macroblock, the same coordinate position macroblocks of all the coded pictures and their adjacent macroblock are used as a block to be determined for being in the still area or the flat area.

9. A recording medium with a moving picture coding program, which makes a computer execute
a step of coding moving picture data in macroblocks;
a step of analyzing coding information of coded pictures and macroblocks at a coding module; and
a step of issuing an instruction of coding to the coding module in pictures or in macroblocks on the basis of an analysis result of the coding information, recorded thereon, wherein
the step of analyzing the coding information performs still area determination and flat area determination for each coding target macroblock; and
the step of issuing the instruction of application of intra flicker suppression processing to macroblocks which have been in a still area and also in a flat area by the coding analyzing.

10. The recording medium of claim 9, wherein
the still area determining determines that the coding target macroblock is in the still area if at least any one of a size of motion vector of the determination target, the number of items of skip coding selection thereof, and a sum of absolute difference in motion detection thereof satisfies determination conditions.

11. The recording medium of claim 9, wherein
the flat area determining determines that the coding target macroblock is in the flat area if at least any one of the number of selected prediction block sizes of the coding target macroblocks of the determination target, the number of selected intra macroblocks in an optimum intra prediction mode in coding or mode determining thereof, and the number of the residual signal non-zero coefficients in the optimum intra prediction mode in coding and mode determining thereof satisfies determination conditions.

12. The recording medium of claim 9, wherein
the coding analyzing uses at least any one of the same coordinate position macroblock in a coded picture just before; the same coordinate position macroblock and its adjacent macroblock, the macroblock just before; its adjacent macroblock and the same coordinate position macroblocks of all the coded pictures; the macroblock just before, its adjacent macroblock, the same coordinate position macroblocks of all the coded pictures and their adjacent macroblock are used as a block to be determined for the still area or the flat area.
